(19) United States
(12) Patent Application Publication
(10) Pub. No.: US 2026/0082007 A1
(43) Pub. Date: Mar. 19, 2026

(54) INFORMATION PROCESSING APPARATUS CAPABLE OF ACQUIRING CARBON DIOXIDE EMISSION AMOUNT, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KENJI SAIKI, Ibaraki (JP)

(21) Appl. No.: 19/321,524

(22) Filed: Sep. 8, 2025

(30) Foreign Application Priority Data
Sep. 19, 2024 (JP) 2024-162398

(51) Int. Cl. H04N 1/00

(52) U.S. Cl. CPC H04N 1/00899; H04N 1/00408

(57) ABSTRACT

An information processing apparatus capable of acquiring an amount of CO2 emitted by generation of a print product such that an amount of CO2 directly emitted by generation of the print product and an amount of CO2 secondarily emitted by generation of the print product are discriminable. An execution time of each processing executed by an image forming apparatus is recorded. A CO2 emission amount of each processing is acquired using a power consumption amount acquired using the record. Amounts of CO2 emitted due to consumables of the image forming apparatus are acquired on a separate basis according to a processing type. A CO2 emission amount of the image forming apparatus is acquired using the amount of CO2 emission acquired of each processing and the amounts of CO2 emission due to the consumables.

### BACKGROUND

### Field of the Technology

The present disclosure relates to an information processing apparatus capable of acquiring an amount of carbon dioxide emission, a method of controlling the information processing apparatus, and a storage medium.

### Description of the Related Art

In recent years, to visualize the environmental load condition, efforts are made for acquiring an emission amount of greenhouse gases, such as carbon dioxide. Also in the field of image forming apparatuses, from a viewpoint that electric power is consumed and toner and sheets are used when a print product is generated, a lot of mechanisms for acquiring an emission amount of greenhouse gases, such as carbon dioxide, have been proposed. For example, Japanese Laid-Open Patent Publication No. 2006-21414 discloses a technique for obtaining amounts of used color materials and sheets and an amount of electric power consumption, based on image data and job information specifying an image formation form when image formation is performed, and calculating an environmental load value from these pieces of information.

Incidentally, in commercial printing/industrial printing, a printing company generates a print product based on document data received from a client. At this time, carbon dioxide is emitted not only during generation of the print product but also during making an image forming apparatus ready for use (such as warming-up and setting of sheets) and taking measures when an abnormality, such as a jam, occurs, and on like occasions. Therefore, there is a problem that the carbon dioxide emission amount to be presented to a client includes not only an amount of carbon dioxide directly emitted when the print product is generated, which is desired by a lot of clients, but also an amount of carbon dioxide secondarily emitted when the print product is generated.

Note that in this specification, the amount of carbon dioxide directly emitted refers to an amount of carbon dioxide emitted only when a job is executed. Therefore, the amount of carbon dioxide directly emitted includes, for example, an amount of carbon dioxide emitted by consumption of electric power of an image forming apparatus, an amount of carbon dioxide emitted by consumption of consumable parts, such as those of a fixing device, an amount of carbon dioxide emitted by using toner and sheets, and so forth, when a print product is generated. On the other hand, the amount of carbon dioxide secondarily emitted refers to an amount of carbon dioxide emitted except when a job is executed and includes an amount of carbon dioxide which is not normally generated when a print product is generated. Therefore, the amount of carbon dioxide which is secondarily emitted includes, for example, an amount of carbon dioxide emitted by warming up an image forming apparatus before execution of a job, an amount of carbon dioxide emitted by consumption of electric power of an image forming apparatus during interruption of processing of the job due to an error occurring during execution of the job, and so forth.

### SUMMARY

The present disclosure is directed to providing an information processing apparatus that is capable of acquiring an amount of carbon dioxide emitted when generating a print product, such that an amount of carbon dioxide directly emitted and an amount of carbon dioxide secondarily emitted are separable, a method of controlling the information processing apparatus, and a storage medium.

In a first aspect of the present disclosure, there is provided an information processing apparatus including a recording unit configured to record an execution time of each processing executed by an image forming apparatus or an image forming system including the image forming apparatus, a first acquisition unit configured to acquire an amount of carbon dioxide emission of each processing executed by the image forming apparatus or the image forming system, by using a power consumption amount acquired by using the record recorded by the recording unit, a second acquisition unit configured to acquire amounts of carbon dioxide emission due to consumables of the image forming apparatus or the image forming system on a separate basis according to a type of processing executed by the image forming apparatus or the image forming system, and a third acquisition unit configured to acquire a carbon dioxide emission amount of the image forming apparatus or the image forming system, by using the amount of carbon dioxide emission acquired by the first acquisition unit and the amounts of carbon dioxide emission acquired by the second acquisition unit.

In a second aspect of the present disclosure, there is provided a method of controlling an information processing apparatus, including recording an execution time of each processing executed by an image forming apparatus or an image forming system including the image forming apparatus, acquiring an amount carbon dioxide emission of each processing executed by the image forming apparatus or the image forming system, by using a power consumption amount acquired by the recording, acquiring amounts of carbon dioxide emission due to consumables of the image forming apparatus or the image forming system on a separate basis according to a type of processing executed by the image forming apparatus or the image forming system, and acquiring a carbon dioxide emission amount of the image forming apparatus or the image forming system, by using the amount of carbon dioxide emission acquired by the first acquisition unit and the amounts of carbon dioxide emission acquired by the second acquisition unit.

Features of the present disclosure will become apparent from the following description of embodiments with reference to the attached drawings. The following description of embodiments are described by way of example.

### BRIEF DESCRIPTION OF THE DRAWINGS

FIG. 1 is a cross-sectional view of an image forming apparatus.

FIG. 2 is a block diagram showing an example of hardware configurations of apparatuses included in the image forming apparatus.

FIG. 3 is a diagram showing an example of a power consumption table showing power consumption in units of Watts of each processing of the apparatuses included in the image forming apparatus.

FIGS. 4A and 4B are diagrams each showing an example of a table used when a carbon dioxide emission amount is acquired.

FIG. 5A is a flowchart of a process performed by a printer included in the image forming apparatus, for acquiring a carbon dioxide emission amount.

FIG. 5B is a flowchart of a printing process.

FIG. 6A is a diagram showing an example of a screen showing operating statuses of the printer included in the image forming apparatus.

FIG. 6B is a diagram showing an example of a screen showing carbon dioxide emission amounts of the printer included in the image forming apparatus.

FIG. 6C is a diagram showing an example of a screen showing carbon dioxide emission amounts of the printer included in the image forming apparatus.

FIG. 6D is a diagram showing an example of a screen showing carbon dioxide emission amounts of the printer included in the image forming apparatus.

FIG. 7 is a block diagram showing an image forming system.

FIG. 8 is a cross-sectional view of a cutting-and-bookbinding apparatus.

FIG. 9 is a diagram showing an example of a power consumption table showing power consumption in units of Watts of each processing of the cutting-and-bookbinding apparatus.

FIG. 10 is a block diagram showing a hardware configuration of a carbon dioxide emission amount acquisition server.

FIG. 11 is a flowchart of a carbon dioxide emissions acquisition process performed by the carbon dioxide emission amount acquisition server.

FIGS. 12A to 12C are diagrams each showing an example of a data sheet showing operation information of each apparatus of the image forming system in a partially extracted state.

FIG. 13A is a diagram showing an example of a screen of a carbon dioxide emission amount acquisition application.

FIG. 13B is a diagram showing an example of a screen of the carbon dioxide emission amount acquisition application.

FIG. 13C is a diagram showing an example of a screen of the carbon dioxide emission amount acquisition application.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of a configuration of the present disclosure can be replaced with desired components which can exhibit the same function. Further, desired components can be added. Further, two or more desired components (features) of the embodiments can be combined. Further, not all combinations of features described in the embodiments are absolutely essential to solution according to the disclosure. Further, the features of the embodiments can be appropriately modified and changed depending on the specification and various conditions (such as a use condition and a use environment) of apparatuses to which the present disclosure is applied.

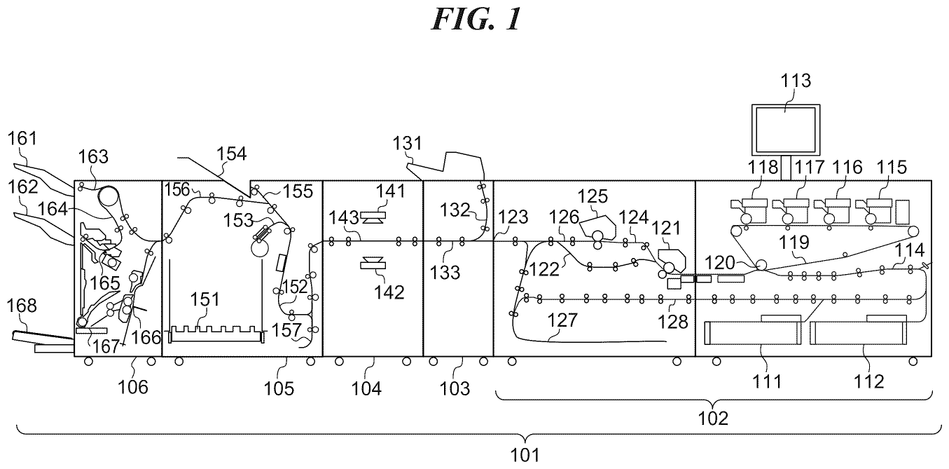

A first embodiment will be described below with reference to FIGS. 1 to 6D.

FIG. 1 is a cross-sectional view of an image forming apparatus 101. The image forming apparatus 101 is formed by a plurality of apparatuses having different functions to make it possible to perform complicated processing related to printing. Specifically, the image forming apparatus 101 has a printer 102, an inserter 103, an inspection device 104, a large-capacity stacker 105, and a finisher 106. The printer 102 is an apparatus that performs printing on a sheet. The printer 102 performs printing with toner on a sheet conveyed from any of sheet feed decks 111 and 112 arranged in lower part thereof. Note that in the first embodiment, the description is given using a sheet as a printing medium, by way of example, but a printing medium other than the sheet can be used. The sheet feed decks 111 and 112 are capable of accommodating a variety of sheets. A user can set information (such as a sheet size and a sheet type) on sheets accommodated in each deck, by using a touch panel 113 of the printer 102, for the sheet feed decks 111 and 112. The touch panel 113 has an operation section and a display (display section). On the display of the touch panel 113, setting information of the image forming apparatus 101, a processing status of a job, and so forth are displayed.

The sheet feed decks 111 and 112 are each capable of separating only one topmost sheet of the accommodated sheets and deliver the sheet to a sheet conveying path 114. Development stations 115 to 118 form toner images by using color toners of Y, M, C, and K, respectively, so as to form a color image. The toner images formed by the development stations 115 to 118 are primarily transferred onto an intermediate transfer belt 119. Further, the intermediate transfer belt 119 rotates in a clockwise direction, as viewed in FIG. 1, whereby the toner image is transferred, at a secondary transfer position 120, onto a sheet conveyed along the sheet conveying path 114.

A fixing unit 121 has a pressure roller and a heating roller. In the fixing unit 121, when each sheet passes between the rollers, the toner is melted and pressed, whereby the toner image is fixed on the sheet. The sheet having passed through the fixing unit 121 is conveyed to a sheet conveying path 123 via a sheet conveying path 122. Depending on a sheet type, the sheet is sometimes required to be further melted and pressed to fix the toner. In this case, the sheet having passed through the fixing unit 121 is conveyed to a second fixing unit 125 via a sheet conveying path 124 which is located upward of the sheet conveying path 122. In the second fixing unit 125, the sheet is additionally subjected to the processing for melting and pressing toner, and then conveyed to the sheet conveying path 123 via a sheet conveying path 126. In a case where a printing mode is set to double-sided printing, the sheet is conveyed to a sheet inversion path 127 and inversed, and is then conveyed along a double-sided print conveying path 128, whereafter image transfer to the second surface is performed at the secondary transfer position 120.

The inserter 103 is an apparatus for inserting a sheet and is capable of inserting a sheet at a desired position with respect to a series of sheets conveyed from the printer 102. The inserter 103 causes a sheet set on an inserter tray 131 to merge with other sheets on a conveying path 133 via a sheet conveying path 132. With this, the inserter 103 can convey a series of sheets conveyed from the printer 102 to a subsequent apparatus while inserting a sheet into a desired position of the series of sheets. The sheets having passed the inserter 103 are conveyed to the inspection device 104.

The inspection device 104 is an apparatus that inspects whether or not printing has been performed without a problem by reading an image on a sheet conveyed from the inserter 103 and comparing the read image with a reference image. In the inspection device 104, cameras 141 and 142 are arranged in a state opposed to each other. The camera 141 is a camera for reading an upper surface of a sheet, and the camera 142 is a camera for reading a lower surface of the sheet. The inspection device 104 is capable of inspecting whether or not an image has been normally printed on a sheet by the printer 102, by reading the image on the sheet conveyed along a sheet conveying path 143, using the cameras 141 and 142, when the sheet reaches a predetermined position. Note that a sheet determined to have a problem in the inspection result is discharged after being separated from a sheet determined as a normal sheet.

The large-capacity stacker 105 is a device in which a large volume of sheets can be stacked. The large-capacity stacker 105 has a stack tray 151 as a tray for stacking thereon sheets determined as the normal sheets. When a sheet determined as a normal sheet by the inspection performed by the inspection device 104 is input to the large-capacity stacker 105 via a sheet conveying path 152, the sheet is stacked on the stack tray 151 from the sheet conveying path 152 via a sheet conveying path 153. Further, the large-capacity stacker 105 has an escape tray 154 as a sheet discharge tray. The escape tray 154 is used to discharge a sheet determined to have a problem by the inspection performed by the inspection device 104. In a case where a sheet is discharged to the escape tray 154, the sheet is discharged to the escape tray 154 from the sheet conveying path 152 via a sheet conveying path 155. Note that in a case where a sheet is conveyed to a subsequent apparatus, the large-capacity stacker 105 conveys the sheet via a sheet conveying path 156.

An inversion section 157 inverts a sheet. The inversion section 157 is used in a case where a sheet is stacked on the stacking tray 151. In the case where a sheet is stacked on the stacking tray 151, the sheet is once inverted at the inversion section 157 such that the direction of the sheet at a time when the sheet is input and the direction of the sheet at a time when the sheet is output coincide with each other. In a case where a sheet is conveyed to the escape tray 154 or the subsequent apparatus, the sheet is directly emitted without being flipped, and hence the inversion operation at the inversion section 157 is not performed.

The finisher 106 is an apparatus that performs finishing processing on a sheet conveyed thereto according to a function designated by a user. Specifically, the finisher 106 has finishing functions, such as stapling (one-position/two-position binding), punching (two holes/three holes), and saddle-stitching bookbinding. The finisher 106 has sheet discharge trays 161 and 162. On the sheet discharge tray 161, a sheet is discharged via a sheet conveying path 163. However, the finisher 106 cannot perform the finishing processing, such as stapling, in the sheet conveying path 163. In a case where the finishing processing, such as stapling, is performed, the finisher 106 conveys a sheet to a processing section 165 via a sheet conveying path 164.

When the finishing function designated by the user is executed by the processing section 165, the sheet is discharged to the sheet discharge tray 162. The sheet discharge trays 161 and 162 can be moved up and down, respectively. Therefore, the finisher 106 can also discharge a sheet on which the finishing processing has been performed by the processing section 165 onto the sheet discharge tray 161 by moving down the sheet discharge tray 161. In a case where saddle-stitching bookbinding is designated, a series of sheets are stapled in the center thereof by a saddle-stitching processing section 166, and then folded in two, whereby a saddle-stitched booklet is made. Further, the saddle-stitched booklet is stacked on a saddle-stitching bookbinding tray 168 via a sheet conveying path 167. The saddle-stitching bookbinding tray 168 is configured as a belt conveyer. Further, a bundle of the saddle-stitched booklets stacked on the saddle-stitching bookbinding tray 168 are conveyed to the left side, as viewed in FIG. 1.

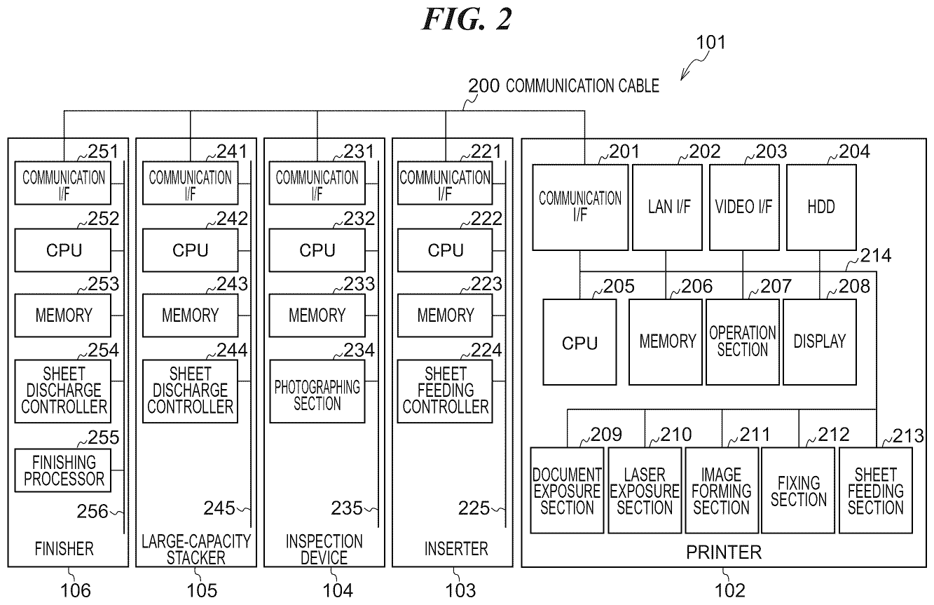

FIG. 2 is a block diagram showing an example of hardware configurations of the apparatuses included in the image forming apparatus 101. The image forming apparatus 101 has a communication cable 200 in addition to the above-described printer 102, inserter 103, inspection device 104, large-capacity stacker 105, and finisher 106. First, the hardware configuration of the printer 102 will be described. The printer 102 includes a communication interface (I/F) 201, a local area network (LAN) I/F 202, a video I/F 203, a hard disk drive (HDD) 204, a central processing unit (CPU) 205, a memory 206, an operation section 207, and a display 208. The printer 102 further includes a document exposure section 209, a laser exposure section 210, an image forming section 211, a fixing section 212, and a sheet feeding section 213. In the printer 102, the above-mentioned components are connected via a system bus 214.

The communication I/F 201 is connected to the inserter 103, the inspection device 104, the large-capacity stacker 105, and the finisher 106 via the communication cable 200. With this, communication for controlling each apparatus is performed via the communication I/F 201. The LAN I/F 202 is connected to a print server or the like, not shown, via a network, not shown, to thereby receive a print instruction. Further, the LAN I/F 202 is connected to a job history server, not shown. With this, communication of job history information and the like is performed via the LAN I/F 202.

At this time, the printer 102 can automatically allocate a job ID for identifying a piece of job history information or can set the job ID by receiving designation provided by the print server or the like or receiving an input from a user. Further, in a case where a job is received from the print server or the like, the printer 102 can record the received job in association with a job identifier of each step related to a print product or instruct the job using the same job ID. Note that the job history information includes information of the client of the job. Further, the CPU 205 stores these pieces of information in the HDD 204 as the information related to the job.

The video I/F 203 is connected to a personal computer (PC) that generates an image for printing or an external controller, not shown, via a video cable, not shown. With this, communication of rasterized image data and the like is performed via the video I/F 203. The HDD 204 is a storage device that stores programs and data. The CPU 205 comprehensively performs image processing control and printing control based on the programs and so forth stored in the HDD 204. The memory 206 is a storage device that stores programs necessary for the CPU 205 to execute a variety of processing operations, and image data, and operates as a work area. The operation section 207 receives an input of a variety of settings and an operation instruction from a user. On the display 208, setting information of the image forming apparatus 101, a job processing status, and so forth are displayed.

The document exposure section 209 performs processing for reading a document when a copy function or a scan function is used. In this processing, the document exposure section 209 reads document data by photographing an image using a charge coupled device (CCD) camera while illuminating a sheet set by a user with an exposure lamp. The laser exposure section 210 is a device that performs primary charging for irradiating a photosensitive drum with laser light to transfer a toner image, and laser exposure. In the laser exposure section 210, first, the primary charging for charging the surface of the photosensitive drum with a uniform negative potential is performed. Next, a laser driver irradiates the photosensitive drum with laser light, while adjusting its reflection angle by using a polygon mirror. With this, negative charges on the irradiated part are neutralized, whereby an electrostatic latent image is formed.

The image forming section 211 is a device for transferring toner to a sheet, which is comprised of a development unit, a transfer unit, a toner replenishment section, and so forth, and transfers toner on the photosensitive drum onto a sheet. In the development unit, negatively charged toner is attached from a developing cylinder to an electrostatic laten image on the surface of the photosensitive drum to visualize the image. In the transfer unit, there are performed primary transfer for transferring the toner on the surface of the photosensitive drum onto a transfer belt by applying a positive potential to a primary transfer roller and secondary transfer for transferring the toner on the transfer belt onto a sheet by applying a positive potential to a secondary transfer outer roller. The fixing section 212 is a device for melting toner on a sheet by heat and fixing the molten toner to the sheet by pressure, and is comprised of a heating heater, a fixing belt, and a pressure belt. The sheet feeding section 213 includes rollers for feeding a sheet and a variety of sensors. In the sheet feeding section 213, an operation of feeding a sheet and an operation of conveying the sheet are controlled by the rollers and the variety of sensors.

Next, the hardware configuration of the inserter 103 will be described. The inserter 103 includes a communication I/F 221, a CPU 222, a memory 223, and a sheet feeding controller 224. In the inserter 103, the above-mentioned components are connected via a system bus 225. The communication I/F 221 is connected to the printer 102 via the communication cable 200. With this, communication necessary for control is performed via the communication I/F 221. The CPU 222 performs a variety of controls necessary for feeding a sheet by control programs stored in the memory 223. The memory 223 is a storage device that stores the control programs. The sheet feeding controller 224 controls feeding and conveyance of a sheet fed by the inserter 103 and a sheet conveyed from the printer 102 while controlling rollers and a variety of sensors based on an instruction from the CPU 222.

Next, the hardware configuration of the inspection device 104 will be described. The inspection device 104 includes a communication I/F 231, a CPU 232, a memory 233, and a photographing section 234. In the inspection device 104, the above-mentioned components are connected via a system bus 235. The communication I/F 231 is connected to the printer 102 via the communication cable 200. With this, communication necessary for control is performed via the communication I/F 231. The CPU 232 performs a variety of controls necessary for inspection by control programs stored in the memory 233.

The memory 233 is a storage device that stores the control programs and so forth. Note that for information stored in the memory 233, the inspection device 104 can be configured, for example, to have a LAN I/F and communicate with a server, a PC, or the like which instructs execution of printing, via an internal LAN. The photographing section 234 photographs a sheet conveyed thereto based on an instruction from the CPU 232. The CPU 232 inspects the sheet by analyzing an image photographed by the photographing section 234. The CPU 232 stores history of execution results of the inspection and setting contents in the memory 233, and when a screen operation and a setting are read out, the CPU 232 uses a reference image by reading out the reference image from the memory 233.

Next, the hardware configuration of the large-capacity stacker 105 will be described. The large-capacity stacker 105 includes a communication I/F 241, a CPU 242, a memory 243, and a sheet discharge controller 244. In the large-capacity stacker 105, the above-mentioned components are connected via a system bus 245. The communication I/F 241 is connected to the printer 102 via the communication cable 200. With this, communication necessary for control is performed via the communication I/F 241. The CPU 242 performs a variety of controls necessary for sheet discharging by control programs stored in the memory 243. The memory 243 is a storage device that stores the control programs. The sheet discharge controller 244 performs control, based on an instruction from the CPU 242, to convey a sheet conveyed thereto, to the stack tray 151, the escape tray 154, or the finisher 106 following the large-capacity stacker 105.

Next, the hardware configuration of the finisher 106 will be described. The finisher 106 includes a communication I/F 251, a CPU 252, a memory 253, a sheet discharge controller 254, and a finishing processor 255. In the finisher 106, the above-mentioned components are connected via a system bus 256. The communication I/F 251 is connected to the printer 102 via the communication cable 200. With this, communication necessary for control is performed via the communication I/F 251. The CPU 252 performs a variety of controls necessary for finishing and sheet discharging by control programs stored in the memory 253. The memory 253 is a storage device that stores the control programs. The sheet discharge controller 254 controls conveyance of a sheet and discharge of a sheet, based on an instruction from the CPU 252. The finishing processor 255 controls finishing processing to be performed on inspected sheets, such as stapling, punching, and saddle-stitching bookbinding, based on an instruction from the CPU 252.

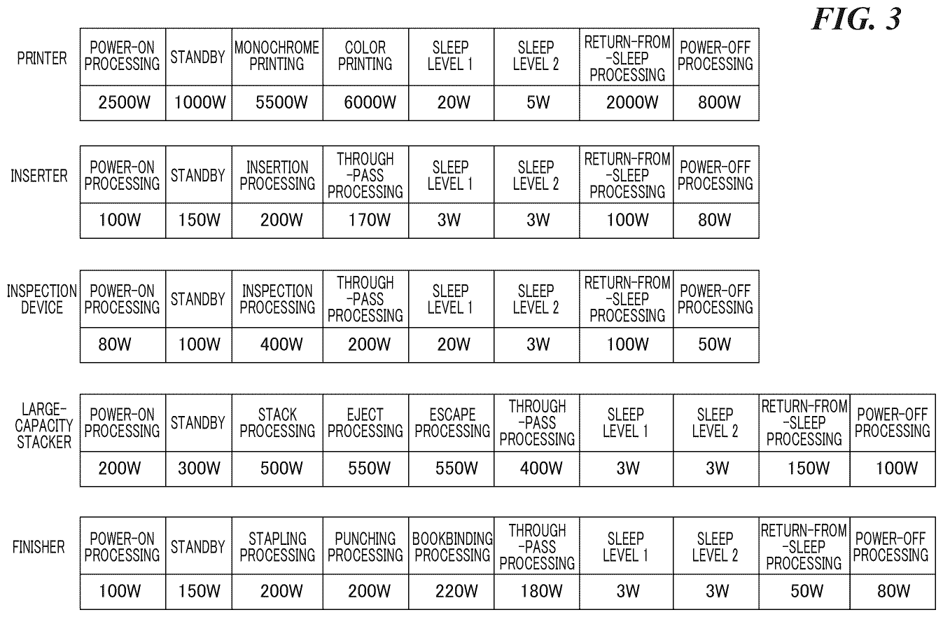

FIG. 3 is a diagram showing an example of a power consumption table showing power consumption in units of Watts on a processing-by-processing basis of the apparatuses included in the image forming apparatus 101. In the power consumption table (definition table) shown in FIG. 3, power consumption amounts in power-ON processing, standby state, sleep level 1, sleep level 2, return-from-sleep processing, and power-OFF processing are defined, commonly to the apparatuses. The sleep level 1 and the sleep level 2 express processing operations in respective stages of a sleep state (power-saving state), and are different in power consumption or sleep restoration time. For the apparatuses except the printer 102, power consumption in through-pass processing is further defined. Note that the through-pass processing is processing for directly passing a sheet to a subsequent apparatus without performing processing in the apparatus.

For the printer 102, power consumption amounts in monochrome printing and color printing are also defined. For the inserter 103, power consumption in insertion processing is also defined. For the inspection device 104, power consumption in inspection processing is also defined. For the large-capacity stacker 105, power consumption amounts in stack processing, eject processing, and escape processing are also defined. For the finisher 106, power consumption amounts in stapling, punching, and bookbinding processing are also defined.

With respect to the processing operations of the standby state, the sleep level 1, and the sleep level 2, the CPU 205 of the printer 102 acquires power consumption amounts on a processing-by-processing basis, by using the power consumption defined for each processing in the power consumption table shown in FIG. 3 and an execution time of each processing. Further, with respect to the processing operations other than the standby state, the sleep level 1, and the sleep level 2, the CPU 205 of the printer 102 acquires power consumption amounts on a processing-by-processing basis, by using the power consumption defined for each processing in the power consumption table shown in FIG. 3 and the number of execution times of each processing. Note that as for the number of execution times, a required time per one processing operation is set to a predetermined time. This point is similarly applied to a second embodiment. Further, the CPU 205 (first acquisition unit) of the printer 102 acquires carbon dioxide emission amounts on a processing-by-processing basis, by using the power consumption amounts on a processing-by-processing basis, thus acquired, and a known conversion technique.

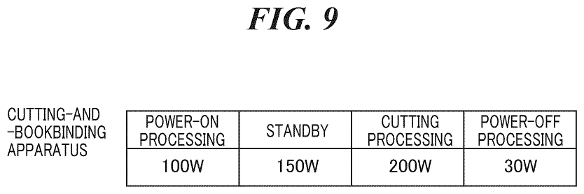

Note that the power supply voltage and the current amount are different from country to country, and hence a plurality of power consumption tables considering these circumstances can be prepared and switched for use. Further, if a wattmeter for measuring power consumption is attached to each apparatus, it is possible to more accurately acquire the carbon dioxide emission amount, but the costs of the image forming apparatus 101 are increased, and hence the wattmeter is not employed in the first embodiment. These points are similarly applied to a power consumption table described hereinafter in the second embodiment with reference to FIG. 9.

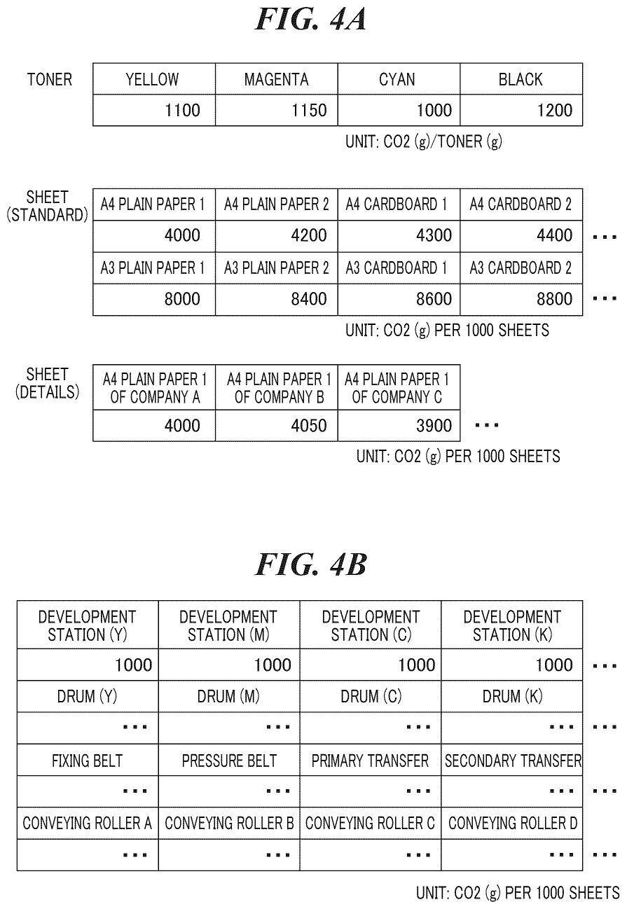

FIG. 4A is a diagram each showing an example of a conversion table used for acquiring an amount of carbon dioxide emitted due to use of the toner/sheets. The carbon dioxide emission amount is different depending on a print product, and particularly depends on the used amounts of toner and sheets. Although there are a plurality of prior art techniques for acquiring a toner used amount, in the first embodiment, the toner used amount is acquired from signal values output when a monochrome image or a color image is formed by the development stations 115 to 118. Further, the acquired toner used amount is converted to a carbon dioxide emission amount according to the conversion table shown in FIG. 4A.

As for the sheets, with respect to a sheet size and a sheet type set for a deck, out of the sheet feed decks 111 and 112, in which the used sheets were accommodated, the number of used sheets (used amount) is converted to a carbon dioxide emission amount according to the conversion table shown in FIG. 4A. In this point, the conversion table shown in FIG. 4A defines not only the carbon dioxide emission amount for each sheet (standard), i.e. for each standard sheet, but also the carbon dioxide emission amount for each sheet (details), i.e. each sheet of a specific product, which makes it possible to acquire a more detailed carbon dioxide emission amount. Note that the carbon dioxide emission amount of each sheet of a specific product can be made ready for use in advance or can be added/edited by a user afterwards.

FIG. 4B is a diagram showing a conversion table in a partially extracted state, which is used when acquiring an amount of carbon dioxide emitted due to consumable parts. Each of the consumable parts is consumed whenever printing is performed, and proper action, such as replacement, is required to be taken at some timing, and hence the carbon dioxide emission amount per unit number of sheets is defined in the conversion table shown in FIG. 4B based on the durable number of sheets to be printed until replacement of an associated consumable part. Therefore, the number of used sheets (used amount) is converted to a carbon dioxide emission amount of the consumable part according to the conversion table shown in FIG. 4B. Note that in the conversion table shown in FIG. 4B, to make it possible to acquire detailed carbon dioxide emission amounts, the carbon dioxide emission amounts are defined on a consumable part-by-consumable part basis. However, the carbon dioxide emission amount per unit number of sheets can be defined with respect to one or a plurality of groups each consisting of consumable parts.

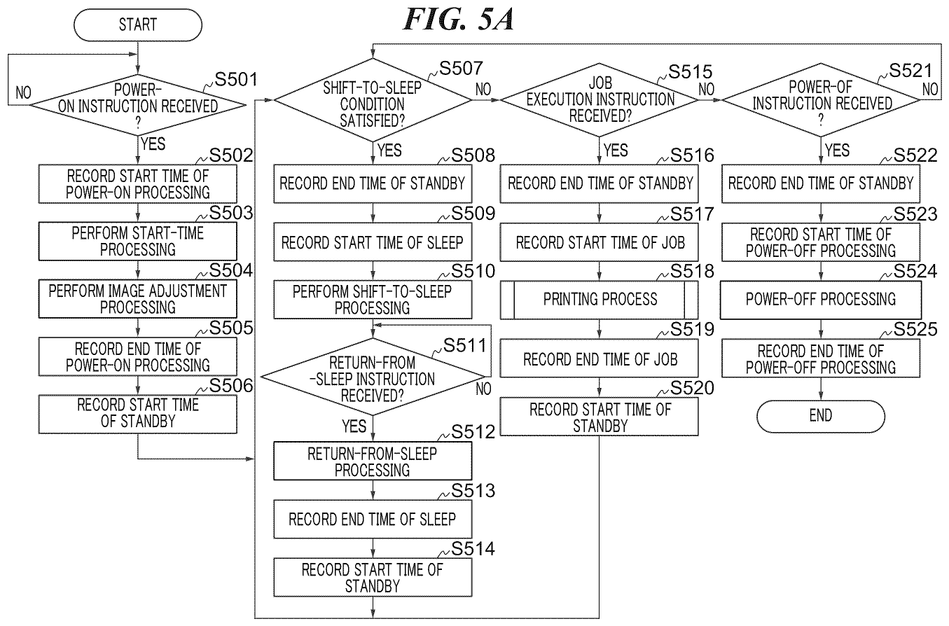

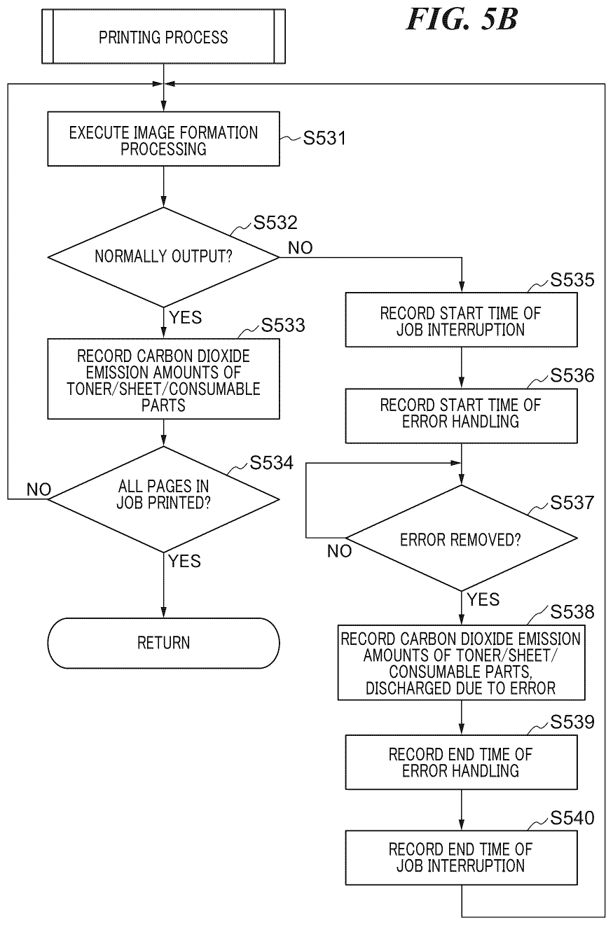

FIG. 5A is a flowchart of a process performed by the printer 102, for acquiring a carbon dioxide emission amount. A series of processing operations (method of controlling the information processing apparatus) in the process in FIG. 5A are realized by the CPU 205 (computer) loading a program stored in the HDD 204 into the memory 206 and executing the loaded program. When the process in FIG. 5A is started, in a step S501, the CPU 205 determines whether or not a power-ON instruction has been received. This determination is performed based on a result of detection of whether or not a power switch, not shown, of the printer 102 has been operated. This point is similarly applied to a step S521, described hereinafter. If it is determined by the CPU 205 that the power-ON instruction has not been received, the process returns to the step S501. On the other hand, if it is determined by the CPU 205 that the power-ON instruction has been received, the process proceeds to a step S502. At this time, the CPU 205 starts power-ON processing. In the step S502, the CPU 205 records a start time of the power-ON processing in the HDD 204.

In a step S503, the CPU 205 performs start-time processing. In the start-time processing, start of the control program, check of operations of the hardware, such as a roller motor, temperature control (including warming-up) for the fixing unit 121 and the second fixing unit 125, and so forth. Note that the CPU 205 instructs the power-ON processing not only to the printer 102, but also to the inserter 103, the inspection device 104, the large-capacity stacker 105, and the finisher 106, via the communication cable 200. In a step S504, the CPU 205 performs image adjustment processing. In the image adjustment processing, if necessary, adjustment accompanying a print operation is performed. Note that the image adjustment processing is a known technique. Therefore, detailed description of the image adjustment processing is omitted.

In a step S505, the CPU 205 records an end time of the power-ON processing in the HDD 204. In a step S506, the CPU 205 records a start time of standby state in the HDD 204. In a step S507, the CPU 205 determines whether or not a shift-to-sleep condition is satisfied. This determination is performed based on a condition set on the operation section 207 in advance. If it is determined by the CPU 205 that the shift-to-sleep condition is satisfied, the process proceeds to a step S508. On the other hand, if it is determined by the CPU 205 that the shift-to-sleep condition is not satisfied, the process proceeds to a step S515, described hereinafter. In the step S508, the CPU 205 records an end time of the standby state in the HDD 204.

In a step S509, the CPU 205 records a start time of sleep in the HDD 204. In a step S510, the CPU 205 performs shift-to-sleep processing. With this, the printer 102 shifts to a power-saving mode. In a step S511, the CPU 205 determines whether or not a return-from-sleep instruction has been received. This determination is performed based on e.g. an operation instruction from the user, which is received on the operation section 207. If it is determined by the CPU 205 that the return-from-sleep instruction has not been received, the process remains in the step S511 to repeat the determination. With this, the printer 102 is placed in a return-from-sleep instruction-waiting state. On the other hand, if it is determined by the CPU 205 that the return-from-sleep instruction has been received, the process proceeds to a step S512. In the step S512, the CPU 205 performs return-from-sleep processing. In the return-from-sleep processing, the temperature control for the fixing unit 121 and the second fixing unit 125, the image adjustment processing, and so forth are performed.

In a step S513, the CPU 205 records an end time of the sleep state in the HDD 204. In a step S514, the CPU 205 records a start time of the standby state in the HDD 204. After that, the process returns to the step S507. In the step S515, the CPU 205 determines whether or not a job execution instruction has been received. This determination is performed based on an operation instruction from the user, which is received on the operation section 207, a print instruction received from a print server, or the like. If it is determined by the CPU 205 that the job execution instruction has been received, the process proceeds to a step S516. On the other hand, if it is determined by the CPU 205 that the job execution instruction has not been received, the process proceeds to the step S521, described hereinafter. In the step S516, the CPU 205 records an end time of the standby state in the HDD 204. In a step S517, the CPU 205 records a start time of the job in the HDD 204. In a step S518, the CPU 205 performs a printing process.

FIG. 5B is a flowchart of the printing process. When the printing process is started, in a step S531, the CPU 205 executes image formation processing. In a step S532, the CPU 205 determines whether or not a sheet has been normally discharged in the image formation processing. If it is determined by the CPU 205 that the sheet has been normally discharged in the image formation processing, the process proceeds to a step S533. On the other hand, if it is determined by the CPU 205 that the sheet has not been normally discharged in the image formation processing, i.e. if some abnormality has occurred, the process proceeds to a step S535, described hereinafter.

In the step S533, the CPU 205 (second acquisition unit) records carbon dioxide emission amounts of the toner/sheet/consumable parts (consumables) used when the sheet has been normally charged in the image formation processing in the HDD 204 according to the conversion tables shown in FIGS. 4A and 4B. In a step S534, the CPU 205 determines whether or not all pages in the job have been printed. If it is determined by the CPU 205 that all pages in the job have been printed, the process returns to the process in FIG. 5A and proceeds to a step S519, described hereinafter. On the other hand, if it is determined that not all pages in the job have been printed, the process returns to the step S531. With this, the processing steps in the process in FIG. 5B are repeated until all pages in the job are printed

In the step S535, the CPU 205 records a start time of interruption of the job in the HDD 204. In a step S536, the CPU 205 records a start time of error handling in the HDD 204. In a step S537, the CPU 205 determines whether or not the error has been removed. If it is determined by the CPU 205 that the error has not been removed, the process remains in the step S537 to repeat the determination. On the other hand, if it is determined by the CPU 205 that the error has been removed, the process proceeds to a step S538. In the step S538, the CPU 205 (second acquisition unit) records a carbon dioxide emission amount of the toner/sheet/consumable parts in the HDD 204 as an amount of carbon dioxide emitted due to the error according to the conversion tables shown in FIGS. 4A and 4B. As a specific example of this, the carbon dioxide emission amount due to a sheet damaged by an error, such as a jam, is recorded. In a step S539, the CPU 205 records an end time of the error handling in the HDD 204. In a step S540, the CPU 205 records an end time of the job interruption in the HDD 204. After that, the process returns to the step S531. With this, the image formation processing is restarted.

The description refers again to FIG. 5A. In the step S519, the CPU 205 records an end time of the job in the HDD 204. In a step S520, the CPU 205 records a start time of the standby state in the HDD 204. After that, the process returns to the step S507. In the step S521, the CPU 205 determines whether or not a power-OFF instruction has been received. If it is determined by the CPU 205 that the power-OFF instruction has not been received, the process returns to the step S507. On the other hand, if it is determined by the CPU 205 that the power-OFF instruction has been received, the process proceeds to a step S522.

In the step S522, the CPU 205 records an end time of the standby state in the HDD 204. In a step S523, the CPU 205 records a start time of power-OFF processing in the HDD 204. In a step S524, the CPU 205 performs the power-OFF processing. In a step S525, before all control programs are terminated by the power-OFF processing, the CPU 205 records an end time of the power-OFF processing in the HDD 204. After that the process in FIG. 5A is terminated.

Thus, the CPU 205 (recording unit) records the times of the processing operations for acquiring the carbon dioxide emission amounts of the printer 102. Further, the CPU 205 records the carbon dioxide emission amounts of the toner/sheet/consumable parts of the printer 102 on a separate basis according to a processing type (here, according to whether or not an error has occurred in processing). Further, the CPU 205 acquires the execution time and the number of execution times of each processing from the records of the time of each processing operation, and acquires the carbon dioxide emission amount of each processing, as described above, based on the execution time and the number of execution times of each processing and the power consumption table shown in FIG. 3. Further, the CPU 205 acquires the carbon dioxide emission amount of the printer 102 by adding up the carbon dioxide emission amounts each acquired on a processing-by-processing basis and the carbon dioxide emission amounts of the toner/sheet/consumable parts.

The CPU 205 acquires the carbon dioxide emission amount of each apparatus of the image forming apparatus 101, other than the printer 102, by using the same method as the method of acquiring the carbon dioxide emission amount of the printer 102. Further, the CPU 205 (third acquisition unit) acquires the carbon dioxide emission amount of the image forming apparatus 101, i.e. an amount of carbon dioxide emitted by generation of a print product in the image forming apparatus 101 by adding up the carbon dioxide emission amounts of the apparatuses of the image forming apparatus 101.

At this time, the CPU 205 can acquire the amount of carbon dioxide emitted only when the job is executed, i.e. the carbon dioxide amount directly emitted by generation of a print product (first emission amount) from the carbon dioxide emission amount of the image forming apparatus 101 by referring to a type of processing executed by the image forming apparatus 101. Similarly, the CPU 205 can acquire the amount of carbon dioxide emitted except when the job is executed, i.e. the carbon dioxide amount secondarily emitted by generation of a print product (second emission amount) from the carbon dioxide emission amount of the image forming apparatus 101 by referring to a type of the processing executed by the image forming apparatus 101.

The executing entity of acquisition of the carbon dioxide emission amount of the image forming apparatus 101 is the CPU 205 of the printer 102 (information processing apparatus) as described above. However, the executing entity of acquisition of the carbon dioxide emission amount of the image forming apparatus 101 is not limited to the CPU 205 of the printer 102 but can be one of the CPUs 222, 232, 242, and 252 of the respective apparatuses of the image forming apparatus 101, other than the printer 102. In this case, an apparatus having a CPU as the executing entity of acquisition of the carbon dioxide emission amount of the image forming apparatus 101 corresponds to the information processing apparatus of the present disclosure. Note that hereinafter, to simplify the explanation, only the carbon dioxide emission amount of the printer 102 will be described, out of the carbon dioxide emission amounts of the image forming apparatus 101.

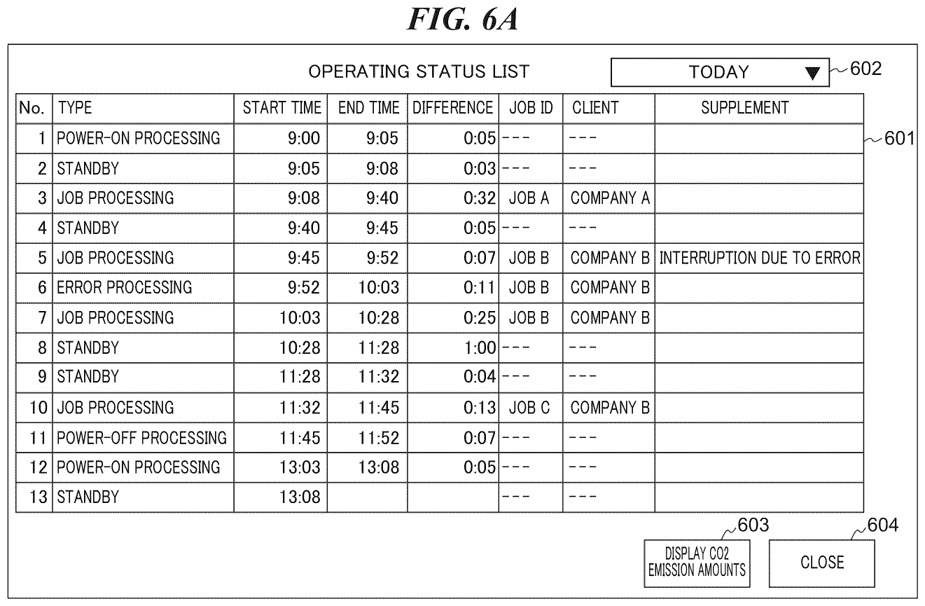

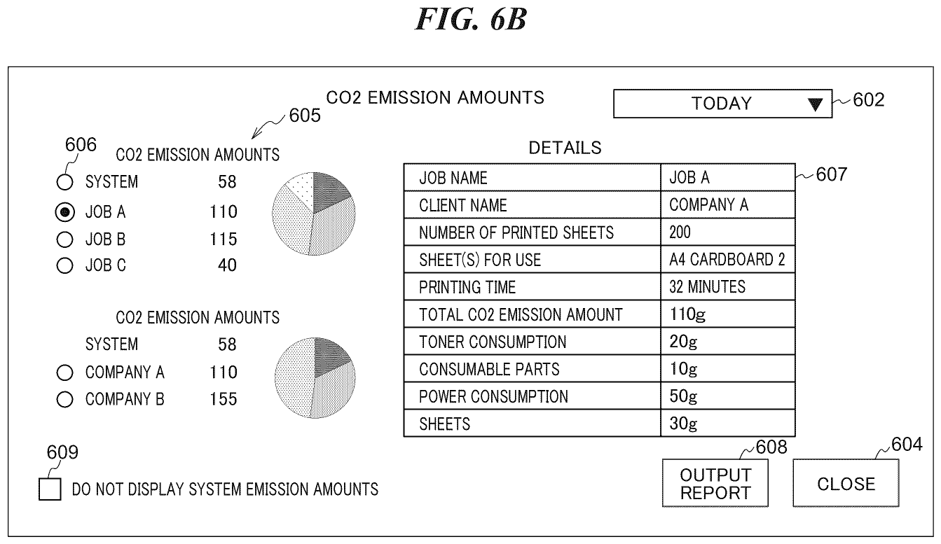

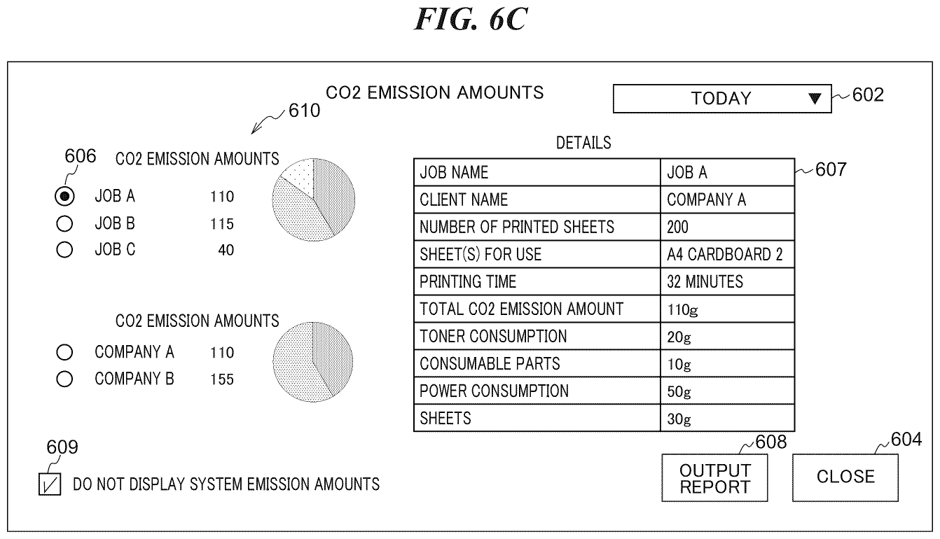

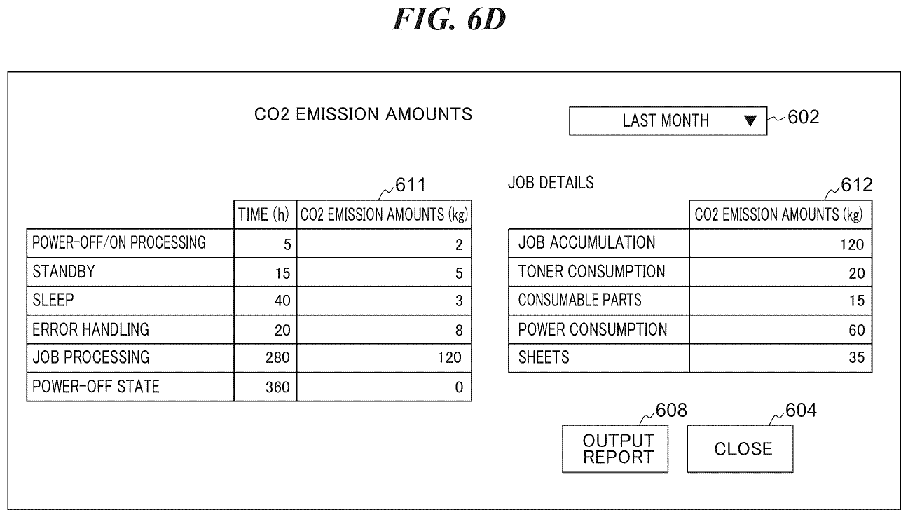

In the following description, the display of the carbon dioxide emission amount of the printer 102 will be described with reference to FIGS. 6A to 6D. FIG. 6A is a diagram showing an example of a screen showing operating statuses of the printer 102. The CPU 205 displays the screen shown in FIG. 6A on the display of the touch panel 113 based on the records of the times of the processing operations described with reference to FIGS. 5A and 5B. Reference numeral 601 denotes a data sheet showing the operating statuses of the printer 102. Reference numeral 602 denotes a dropdown menu (fourth UI component) for prompting a user to select a specific time period. Reference numeral 603 denotes a button for displaying the carbon dioxide emission amounts. Reference numeral 604 denotes a button for closing the screen.

The contents displayed in the data sheet 601 are based on the times recorded in the processes in FIGS. 5A and 5B during a specific time period selected from the dropdown menu 602. For example, the start time (9:00) of the power-ON processing in NO. 1 is the time recorded in the step S502, and the end time (9:05) is the time recorded in the step S505. The start time (9:08) of the job processing in NO. 3 is the time recorded in the step S517, and the end time (9:40) is the time recorded in the step S519. The start time (9:52) of the error handling in NO. 6 is the time recorded in the step S536, and the end time (10:03) is the time recorded in the step S539. The CPU 205 acquires a job ID and a client based on the information related to the job. Further, the CPU 205 acquires the execution time and the number of execution times of each processing based on a difference between the start time and the end time of each processing.

FIGS. 6B to 6D are diagrams each showing an example of a screen showing the carbon dioxide emission amounts of the printer 102. The CPU 205 displays each of the screens shown in FIGS. 6B to 6D on the display of the touch panel 113. At this time, the display of each of the screens shown in FIGS. 6B to 6D by the CPU 205 is performed based on the records of times of the processing operations, which are recorded during the processes in FIGS. 5A and 5B, and the records of the carbon dioxide emission amounts of the toner/sheet/consumable parts during the specific time period selected from the dropdown menu 602. The screen shown in FIG. 6B is displayed on the display of the touch panel 113 when the button 603 on the screen shown in FIG. 6A is pressed. Reference numeral 605 denotes a display area showing details of the carbon dioxide emission amounts of the printer 102, by using item names, values, and circle graphs. Reference numeral 606 denotes each of radio buttons (second UI component) (third UI component) for prompting a user to select only one of the items shown in the display area 605. Reference numeral 607 denotes a data sheet showing details of an item selected as a target by the radio button 606, including the carbon dioxide emission amount. Reference numeral 608 denotes a button for outputting a report print.

Reference numeral 609 denotes a checkbox (first UI component) for displaying a system emission amount. Note that the radio buttons 606 and the checkbox 609 can be configured as other UI components. When the checkbox 609 is checked, the screen shown in FIG. 6C is displayed on the display of the touch panel 113. In FIG. 6C, reference numeral 610 denotes a display area showing details of the carbon dioxide emission amounts of the printer 102 at a time when the system emission amount is hidden, by using item names, values, and circle graphs. The system emission amount (second emission amount), referred to, on the screens shown in FIGS. 6B and 6C refers to the amount of carbon dioxide emitted except when a job is executed, i.e. the carbon dioxide amount secondarily emitted by generation of a print product. Therefore, a value of “58” indicated in association with the item name of “system” in the display area 605 on the screen, shown in FIG. 6B, indicates the amount of carbon dioxide emitted from the printer 102 except when the job is executed. Further, when the screen shown in FIG. 6C is displayed by checking the checkbox 609, only the amounts of carbon dioxide emitted only when the job is executed, i.e. the carbon dioxide emission amounts directly emitted by generation of a print product (first emission amount) are displayed.

The CPU 205 acquires the carbon dioxide emission amounts on a job-by-j0b basis, based on the carbon dioxide emission amounts converted from the power consumption amounts in the job processing in the data sheet 601 on the screen shown in FIG. 6A, the carbon dioxide emission amounts of the toner/sheet/consumable parts, and the information related to the job. The CPU 205 further acquires the carbon dioxide emission amount for each client of the job based on the information related to the job. Thus, the amounts of carbon dioxide emitted only when the job is executed, i.e. the carbon dioxide emissions directly emitted by generation of a print product (first emission amount) are acquired on a separate basis for each job and for each client of the job. Further, the CPU 205 acquires the amounts of carbon dioxide emitted in the processing operations other than the job processing (the power-ON processing, the standby state, the sleep state, the error handling, and the power-OFF processing) in the data sheet 601 on the screen shown in FIG. 6A as the system emission amount. The CPU 205 (display unit) displays the display area 605 and the data sheet 607 on the screen shown in FIG. 6B and displays the display area 610 and the data sheet 607 on the screen shown in FIG. 6C based on these acquired results.

Thus, by the display area 610 on the screen shown in FIG. 6C, the CPU 205 can acquire and display the carbon dioxide emission amounts specific to jobs and clients each with respect to the amount of carbon dioxide emitted only when a job is executed, i.e. the emission amount directly emitted by generation of a print product. With this, the image forming apparatus 101 can prevent excessive presentation, to the client of a job, of carbon dioxide emission amounts including the amounts of carbon dioxide emitted except when the job is executed, i.e. the emission amounts secondarily emitted by generation of a print product. Further, the CPU 205 outputs the contents displayed on the screen shown in FIG. 6B or 6C as a report print when the button 608 is pressed. Note that the CPU 205 can transmit electronic data of the operating statuses and the carbon dioxide emission amounts to the print server or the like via the LAN I/F 202.

When the specific time period is changed by using the dropdown menu 602, appearing in FIGS. 6A to 6C, the time period for acquiring the carbon dioxide emission amount to be displayed is also changed to the specific time period changed by using the dropdown menu 602. In this point, if the specific time period is changed by unit of a day, it is meaningful to display the carbon dioxide emission amounts on a job-by-job basis, as indicated by the screens shown in FIGS. 6B and 6C. However, if the specific time period is changed by unit of a relatively longer period, such as a month, it is less meaningful to display the carbon dioxide emission amounts on a job-by-job basis. So, in a case where the specific time period changed by using the dropdown menu 602 is a time period of a relatively long unit, the CPU 205 displays the screen shown in FIG. 6D on which the carbon dioxide emission amounts of all jobs in this time period are collected, on the display of the touch panel 113.

In FIG. 6D, reference numeral 611 denotes a data sheet showing the execution time and the carbon dioxide emission amount with respect to each processing performed by the printer 102. Reference numeral 612 denotes a data sheet showing details of the carbon dioxide emission amount of the printer 102, by the carbon dioxide emission amounts of job accumulation, toner consumption, consumable parts, electric power, and sheets. Note that in the data sheet 611, the carbon dioxide emission amount of each job processing (first emission amount) is displayed, and further, the system emission amount (second emission amount) is displayed in a state divided into the carbon dioxide emission amounts of the power-OFF/ON processing, the standby state, the sleep state, and the error handling. With this, the user can confirm how much amount of carbon dioxide has been emitted in each processing in the specific time period changed by using the dropdown menu 602.

As described above, in the first embodiment, the image forming apparatus 101 acquires the carbon dioxide emission amount of the image forming apparatus 101 by acquiring the carbon dioxide emission amount based on power consumption of each processing and acquiring the carbon dioxide emission amounts of the toner/sheet/consumable parts on a separate basis according to a processing type. With this, it is possible to acquire the carbon dioxide emission amount of the image forming apparatus 101, i.e. the amount of carbon dioxide emitted by generation of a print product, such that the amount of carbon dioxide directly emitted and the amount of carbon dioxide secondarily emitted are discriminable.

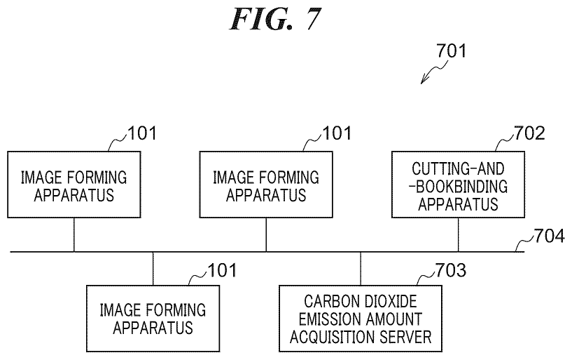

The second embodiment will be described below with reference to FIGS. 7 to 13C. In the first embodiment, the carbon dioxide emission amount of the image forming apparatus 101 is acquired by the printer 102 included in the image forming apparatus 101. On the other hand, a lot of companies providing commercial printing/industrial printing services sometimes use a plurality of image forming apparatuses or use a post-processing apparatus for performing bookbinding and surface processing in combination with the image forming apparatus. So, in the second embodiment, a method of collectively managing a plurality of image forming apparatuses and the post-processing apparatus and acquiring the carbon dioxide emission amount of each apparatus will be described. Note that in the second embodiment, a description will be given of a difference from the first embodiment. Therefore, in the second embodiment, the same components as those of the first embodiment are denoted by the same reference numerals, and description thereof is omitted.

FIG. 7 is a block diagram showing an image forming system 701. The image forming system 701 includes the three image forming apparatuses 101, a cutting-and-bookbinding apparatus 702, and a carbon dioxide emission amount acquisition server 703 (information processing apparatus). In the image forming system 701, the three image forming apparatuses 101, the cutting-and-bookbinding apparatus 702, and the carbon dioxide emission amount acquisition server 703 are connected via a network 704. Hereinafter, when collectively referring to the three image forming apparatuses 101 and the cutting-and-bookbinding apparatus 702 except the carbon dioxide emission amount acquisition server 703, they are described as the apparatuses of the image forming system 701. Note that in the second embodiment, to simplify the explanation, the three identical image forming apparatuses 701 are connected to the network 704, but a different image forming apparatus from the image forming apparatus 101 can be connected. Further, the cutting-and-bookbinding apparatus 702 is an example of the post-processing apparatus, and can be a different post-processing apparatus.

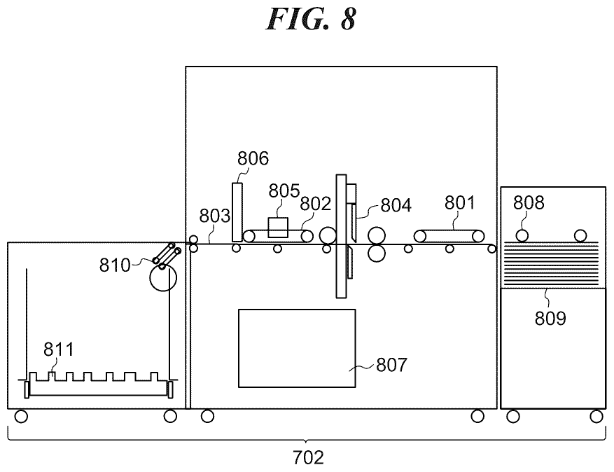

FIG. 8 is a cross-sectional view of the cutting-and-bookbinding apparatus 702. The cutting-and-bookbinding apparatus 702 is a general three-way cutting machine that is capable of cutting a sheet in three directions. In the cutting-and-bookbinding apparatus 702, part of the apparatus, which cuts sheets, is provided with conveying sections 801 to 803, a cutter section 804 which cuts sheets, a press section 805 which fixes sheets, an abutment section 806, and a disposal box 807. The cutting-and-bookbinding apparatus 702 beautifully aligns edges of a sheet bundle which has been bound into a book by controlling the cutter section 804 to cut sheets to a length determined in advance. Further, in the cutting-and-bookbinding apparatus 702, part of the apparatus, which feeds and discharges sheets, is provided with a sheet feed roller 808, a sheet feed tray 809, a sheet discharge roller 810, and a sheet discharge tray 811.

Hereafter, a flow of cutting a sheet in the cutting-and-bookbinding apparatus 702 will be described. When a sheet is fed from the top of the sheet feed tray 809 by the sheet feed roller 808, and further, the sheet is conveyed to a cutting position by the conveying sections 801 and 802, the sheet position is adjusted by the abutment section 806. Then, the cutter section 804 is moved down in a state in which the sheet is fixed by the press section 805, whereby the sheet is cut. Cut part of the sheet, generated in this cutting step, drops by self-weight and is accommodated into the disposal box 807. Note that in the cutting-and-bookbinding apparatus 702, not only the cutter section 804, but also cutter sections, not shown, are arranged on a near side and a far side of the sheet conveying direction, respectively. With this, the cutting-and-bookbinding apparatus 702 is configured to be capable of performing not only sheet-edge cutting, but also three-way cutting.

Further, the cutter section 804 has a mechanism for adjusting the cutting position in the sheet conveying direction, which makes it possible to adjust the cutting position from the sheet edge. Further, the cutter sections arranged on the near side and the far side of the sheet conveying direction, respectively, each have a mechanism, not shown, for adjusting the cutting position in a width direction of the sheet, which makes it possible to adjust the cutting position from the near side and the far side of the sheet conveying direction, respectively. The cut sheet passes the conveying section 803 and is further discharged to the sheet discharge tray 811 by the sheet discharge roller 810. Note that although the flow of cutting a sheet has been described here based on an example in which one sheet is fed, a plurality of fed sheets can be cut, or sheets fed on a bundle basis can be cut.

FIG. 9 is a diagram showing an example of a power consumption table showing power consumption in units of Watts of each processing of the cutting-and-bookbinding apparatus 702. In the power consumption table (definition table) shown in FIG. 9, the power consumption amounts in the power-ON processing, the standby state, the cutting processing, and the power-OFF processing are defined for the cutting-and-bookbinding apparatus 702. Similar to the first embodiment, in the second embodiment as well, with respect to processing in the standby state, the power consumption of this processing is acquired from the power consumption defined as to the processing on the power consumption table shown in FIG. 9 and the execution time of the processing. On the other hand, with respect to the power-ON processing, the cutting processing, and the power-OFF processing, the power consumption of each processing is acquired from the power consumption defined for each processing on the power consumption table shown in FIG. 9 and the number of execution times of each processing. Further, the carbon dioxide emission amount of each processing is acquired by using the power consumption of each processing, which is acquired as described above, and a known conversion technique.

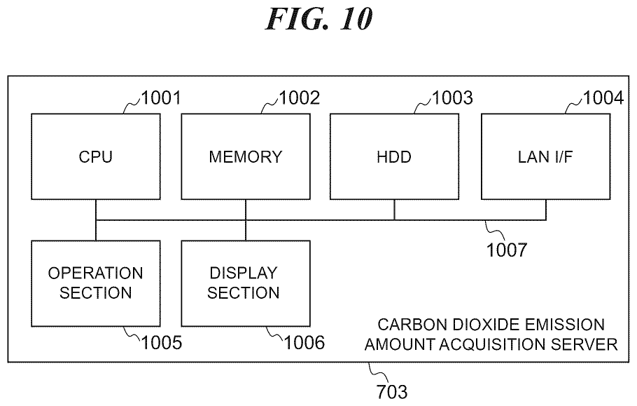

FIG. 10 is a block diagram showing a hardware configuration of the carbon dioxide emission amount acquisition server 703. The carbon dioxide emission amount acquisition server 703 includes a CPU 1001, a memory 1002, an HDD 1003, a LAN I/F 1004, an operation section 1005, and a display section 1006. In the carbon dioxide emission amount acquisition server 703, the above-mentioned components are connected via a system bus 1007. The CPU 1001 comprehensively performs processing operations, such as reception of job history information and operation information from each image forming apparatus 101 and the cutting-and-bookbinding apparatus 702 and acquisition of the carbon dioxide emission amount, according to the programs and data stored in the HDD 1003.

The memory 1002 operates as a work area. The HDD 1003 is a storage device that stores the programs necessary when the CPU 1001 performs a variety of processing operations, data, and carbon dioxide emission amount acquisition application software (hereinafter simplified as the carbon dioxide emission amount acquisition application). The LAN I/F 1004 is connected to each image forming apparatus 101 and the cutting-and-bookbinding apparatus 702 via the network 704. With this, communication for receiving the job history information, the operation information, and so forth is performed via the LAN I/F 1004. The CPU 1001 stores these pieces of information in the HDD 1003 as the information related to a job. The operation section 1005 is a device that receives inputs of a variety of settings and an operation instruction from a user. On the display section 1006, information of the carbon dioxide emission amount acquisition application executed by the carbon dioxide emission amount acquisition server 703, and so forth, are displayed.

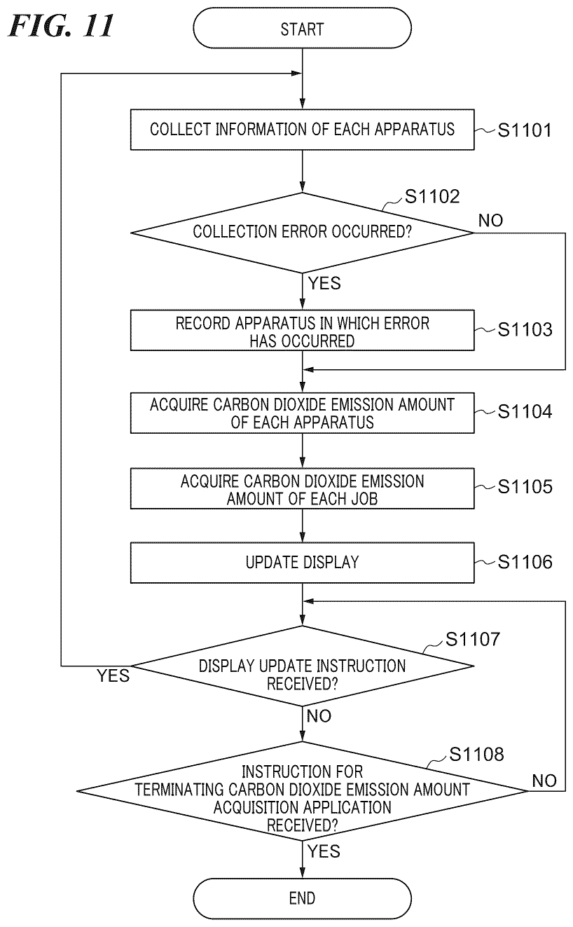

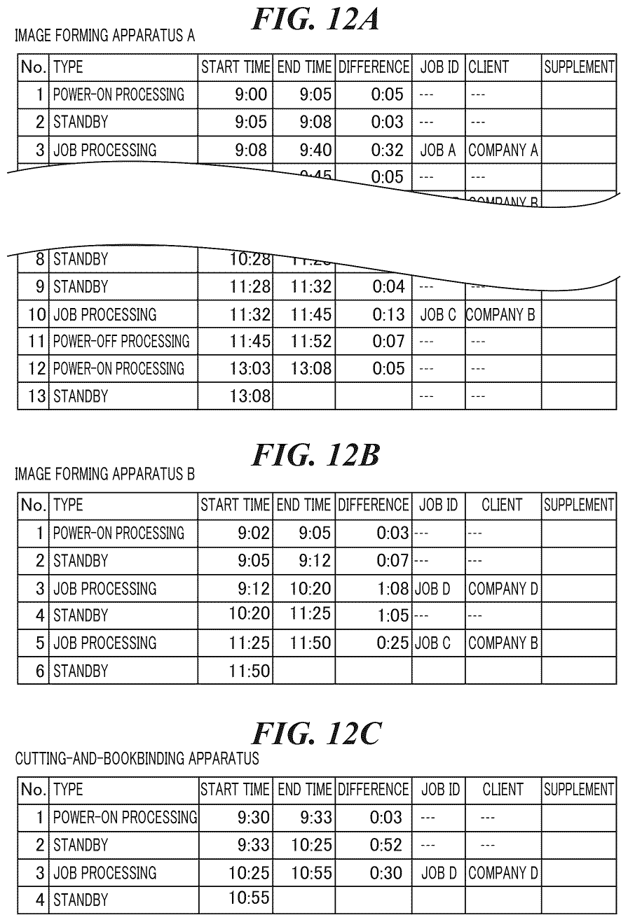

Acquisition and display of carbon dioxide emission amounts, which are performed by the carbon dioxide emission amount acquisition server 703, will be described with reference to FIGS. 11 to 13C. FIG. 11 is a flowchart showing a process performed by the carbon dioxide emissions acquisition server 703, for acquiring a carbon dioxide emission amount. FIGS. 12A to 12C are diagrams each showing an example of a data sheet showing operation information of each apparatus of the image forming system 701 in a partially extracted state. The data sheets shown in FIGS. 12A and 12B show the operation information of the two image forming apparatuses 101 of the three image forming apparatuses 101. Note that each apparatus of the image forming system 701 acquires the operation information of the apparatus, by executing the same processes in FIGS. 5A and 5B, described in the first embodiment.

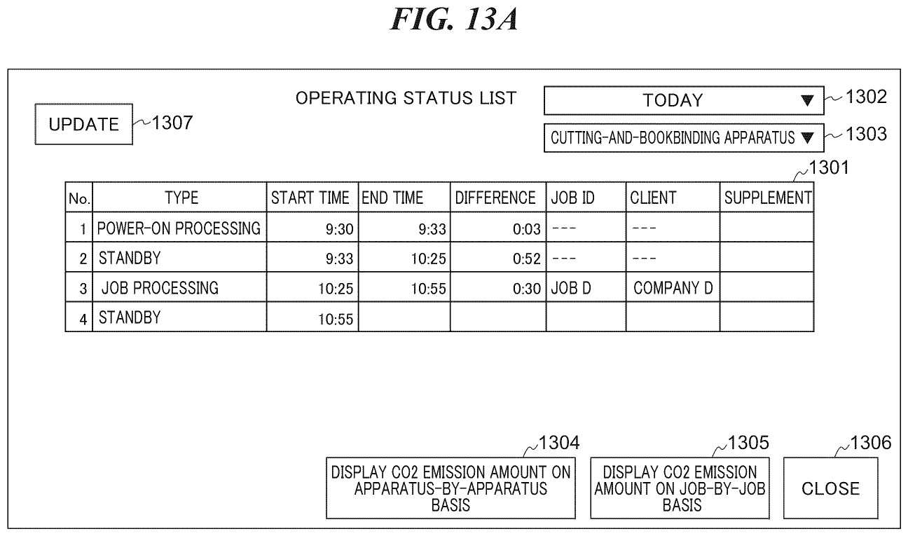

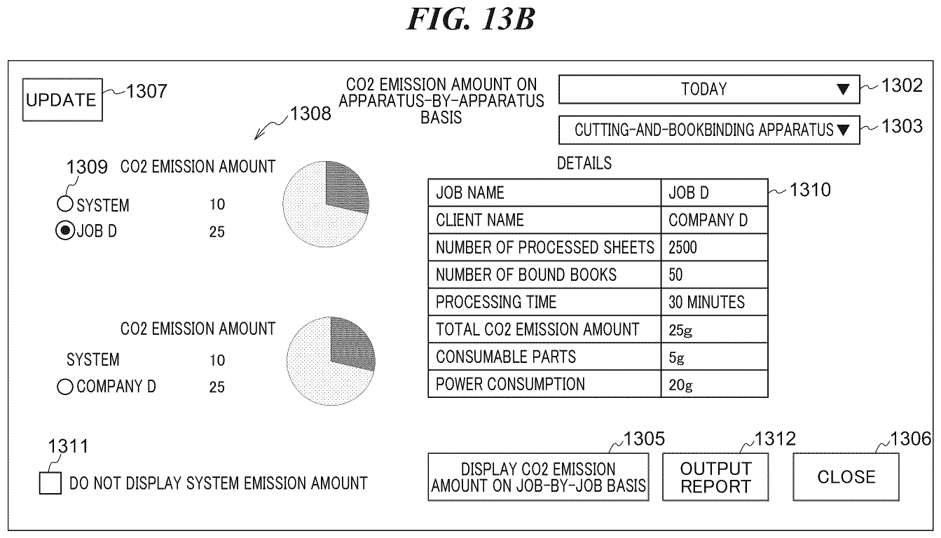

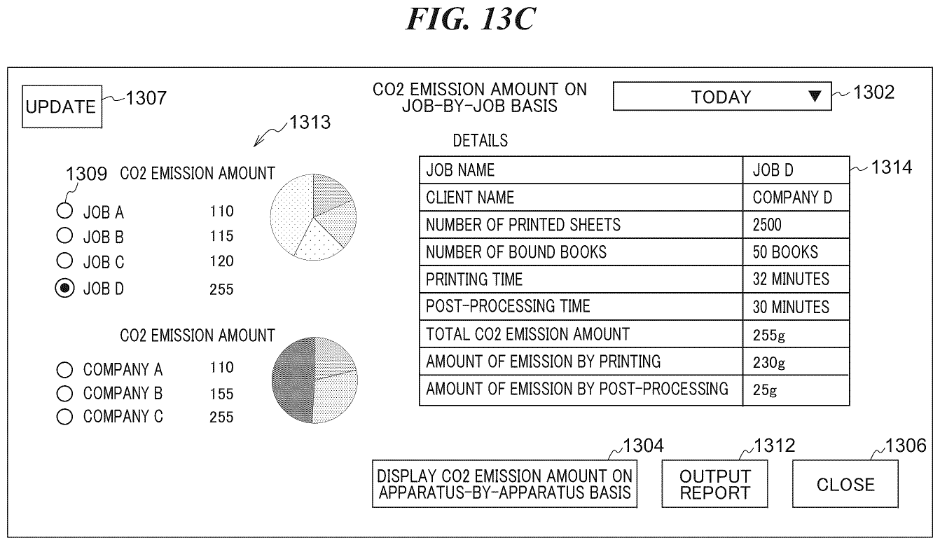

FIGS. 13A to 13C are diagrams each showing an example of a screen of the carbon dioxide emission amount acquisition application. The screens shown in FIGS. 13A to 13C are displayed on the display section 1006 of the carbon dioxide emission amount acquisition server 703. Further, UI components of the screens shown in FIGS. 13A to 13C are operated by the operation section 1005 of the carbon dioxide emission amount acquisition server 703. Note that the screens shown in FIGS. 13A to 13C can be displayed on an information processing apparatus, not shown, connected to the network 704. Further, details of FIGS. 13A to 13C will be described hereinafter.

A series of processing operations (method of controlling the information processing apparatus) in the process in FIG. 11 are realized by the CPU 1001 (computer) loading a program stored in the HDD 1003 into the memory 1002 and executing the loaded program. The process in FIG. 11 is started by using, as a trigger, execution of the carbon dioxide emission amount acquisition application. When the process in FIG. 11 is started, in a step S1101, the CPU 1001 (recording unit) collects information related to a job, such as the operation information shown in FIG. 12, from each apparatus of the image forming system 701. At this time, the CPU 1001 also acquires the carbon dioxide emission amounts of the toner/sheet/consumable parts (consumables) from each apparatus of the image forming system 701 together with the operation information.

In a step S1102, the CPU 1001 determines whether or not a collection error has occurred. Note that examples of the case where a collection error occurs include a case where each apparatus of the image forming system 701 is in a powered-off state and a case where some problem has occurred in the network communication. If it is determined by the CPU 1001 that a collection error has occurred, the process proceeds to a step S1103. On the other hand, if it is determined by the CPU 1001 that a collection error has not occurred, the process proceeds to a step S1104, described hereinafter. In the step S1103, the CPU 1001 records an apparatus of the apparatuses of the image forming system 701, in which the collection error has occurred, in the HDD 1003.

In the step S1104, the CPU 1001 acquires the carbon dioxide emission amounts of the apparatuses of the image forming system 701, by using the information related to the job, such as the operation information, which is collected in the step S1101, and the carbon dioxide emission amounts of the toner/sheet/consumable parts. With this, the carbon dioxide emission amount of the image forming system 701 is also acquired. The CPU 1001 (first acquisition unit, third acquisition unit) performs the acquisition processing in the step S1104 by using the same method as that used in the first embodiment. In a step S1105, the CPU 1001 acquires the carbon dioxide emission amount of each job of the image forming system 701, by using the information related to the job, such as the operation information, which is collected in the step S1101, and the carbon dioxide emission amounts of the toner/sheet/consumable parts. The CPU 1001 further acquires the carbon dioxide emission amount for each client of the job based on the information related to the job.

Thus, the CPU 1001 acquires the amount of carbon dioxide emitted only when a job is executed, i.e. the emission amount directly emitted by generation of a print product on a separate basis for each job and each client of the job. Therefore, it is possible to display the amount of carbon dioxide emitted only when a job is executed, i.e. the emission amount directly emitted by generation of a print product on a separate basis for each job or each client of the job, as shown in FIG. 13C. With this, the carbon dioxide emission amount acquisition server 703 can prevent excessive presentation, to the client of a job, of carbon dioxide emission amounts including the amounts of carbon dioxide emitted except when the job is executed, i.e. the emission amounts secondarily emitted by generation of a print product.

In the second embodiment, the NO. 10 in FIG. 12A and NO. 5 in FIG. 12B have common records of the job ID=job C and the client=company B. This is because the job C has been divided and input to the two image forming apparatuses 101 to reduce the printing time. So, the CPU 1001 displays the carbon dioxide emission amount of the job C as indicated in a display area 1313 on the screen shown in FIG. 13C by adding up the carbon dioxide emission amounts with respect to the job C. Further, NO. 3 in FIG. 12B and NO. 3 in FIG. 12C have common records of the job ID=job D and the client=company D. This indicates that a print product generated by the image forming apparatus 101 corresponding to the image forming apparatus B has been post-processed by the cutting-and-bookbinding apparatus 702. So, the CPU 1001 displays the carbon dioxide emission amount and so forth of the job D as indicated in the display area 1313 and a data sheet 1314, on the screen shown in FIG. 13C, by adding up the carbon dioxide emission amounts and so forth with respect to the job D.

The description refers again to FIG. 11. In a step S1106, the CPU 1001 updates the display of a screen being displayed on the display section 1006, out of the screens shown in FIGS. 13A to 13C. In a step S1107, the CPU 1001 determines whether or not an instruction for updating the display has been received. This determination is performed based on whether or not an operation of pressing the button 1307 has been detected from one of the screens shown in FIGS. 13A to 13C. If it is determined by the CPU 1001 that an instruction for updating the display has been received, i.e. an operation of pressing the button 1307 has been detected, the process returns to the step S1101. With this, collection of the information, acquisition of the carbon dioxide emission amount, and the update of the display are performed again. On the other hand, if it is determined by the CPU 1001 that an instruction for updating the display has not been received, i.e. an operation of pressing the button 1307 has not been detected, the process proceeds to a step S1108.

In the step S1108, the CPU 1001 determines whether or not an instruction for terminating the carbon dioxide emission amount acquisition application has been received. This determination is performed based on e.g. an operation instruction received from the user via the operation section 1005. If it is determined by the CPU 1001 that the instruction for terminating the carbon dioxide emission amount acquisition application has not been received, the process returns to the step S1107. On the other hand, if it is determined by the CPU 1001 that the instruction for terminating the carbon dioxide emission amount acquisition application has been received, the process in FIG. 11 is terminated.

The screen shown in FIG. 13A is an example of a screen showing the operation information of the apparatuses of the image forming system 701. Reference numeral 1301 denotes a data sheet showing the operation information of one of the apparatuses of the image forming system 701. Note that the CPU 1001 acquires a job ID and a client based on the information related to the job. Reference numeral 1302 denotes a dropdown menu (fourth UI component) for prompting a user to select a specific time period. By using the dropdown menu 1302, the user can change a time period of the operation information to be displayed in the data sheet 1301. Reference numeral 1303 denotes a dropdown menu (fifth UI component) for prompting a user to select one apparatus from the apparatuses of the image forming system 701. By using the dropdown menu 1303, the user can change the apparatus, the operation information of which is displayed in the data sheet 1301.

Reference numeral 1304 denotes a button for displaying the carbon dioxide emission amount for each apparatus of the image forming system 701. When the button 1304 is pressed, the screen shown in FIG. 13B is displayed on the display section 1006. Reference numeral 1305 denotes a button for displaying the carbon dioxide emission amounts, on a job-by-job basis, of the image forming system 701. When the button 1305 is pressed, the screen shown in FIG. 13C is displayed on the display section 1006. Reference numeral 1306 denotes a button for closing the screen. Reference numeral 1307 denotes a button for updating the display on the screen.

FIG. 13B is a diagram showing an example of a screen showing the carbon dioxide emission amount of the apparatus selected by the dropdown menu 1303. The screen shown in FIG. 13B has not only the dropdown menus 1302 and 1303, and the buttons 1305 to 1307, but also a display area 1308, a radio button 1309, a data sheet 1310, a checkbox 1311, and a button 1312. The display area 1308 is an area showing details of the amount of carbon dioxide emitted in the specific time period selected by the dropdown menu 1302 with respect to the apparatus selected by the dropdown menu 1303, by using item names, values, and circle graphs. The radio button 1309 is a UI component (second UI component, third UI component) for prompting a user to select one of the items displayed in the display area 1308. The data sheet 1310 is a sheet showing details of an item selected as a target by the radio button 1309, including the amount of carbon dioxide emitted in the specific time period selected by the dropdown menu 1302.

The checkbox 1311 (first UI component) is a UI component for hiding the system emission amount. On the screen shown in FIG. 13B, the system emission amount (second emission amount) refers to the amount of carbon dioxide emitted except when a job is executed, i.e. the carbon dioxide amount secondarily emitted by generation of a print product. Therefore, in the display area 1308, a value of “10” indicated in association with the item name of “system” indicates the amount of carbon dioxide emitted except when a job is executed in the cutting-and-bookbinding apparatus 702. When the checkbox 1311 is checked, the display related to the system emission amount is deleted, and only the amount of carbon dioxide emitted only when a job is executed, i.e. the emission amount directly emitted by generation of a print product (first emission amount) is displayed.

Thus, the CPU 1001 (display unit) displays the system emission amount and the amount of carbon dioxide emitted only when a job is executed, i.e. the emission amount directly emitted by generation of a print product (first emission amount), on a separate basis, in the display area 1308. Note that the radio button 1309 and the checkbox 1311 can be other UI components. The button 1312 is a UI component for outputting the contents displayed on the screen as a report print.

FIG. 13C is a diagram showing an example of a screen showing the carbon dioxide emission amounts, on a job-by-job basis, of the image forming system 701. The screen shown in FIG. 13C has not only the dropdown menus 1302, the buttons 1304, 1306, 1307, and 1312, and the radio button 1309, but also the display area 1313 and the data sheet 1314. The display area 1313 is a display area showing the details of the amount of carbon dioxide emitted only when a job is executed in the specific time period selected by the dropdown menu 1302, i.e. the emission amount directly emitted by generation of a print product, by using item names, values, and circle graphs.

The data sheet 1314 is a data sheet showing details of an item selected by the radio button 1309, including the amount of carbon dioxide emitted in the specific time period selected by the dropdown menu 1302. Note that, in the image forming system 701, in a case where a job has been divided and input to the image forming apparatuses 101, in the display area 1313 and the data sheet 1314, the carbon dioxide emission amounts and the like of this job in the respective image forming apparatuses 101 are added up and displayed, as described above. This point is similarly applied to a case where a print product generated by the image forming apparatus 101 is post-processed by the cutting-and-bookbinding apparatus 702 in the image forming system 701.

As described above, the carbon dioxide emission amount acquisition server 703 is connected to each image forming apparatus 101 and the cutting-and-bookbinding apparatus 702 as the post-processing apparatus in the image forming system 701. Further, the carbon dioxide emission amount acquisition server 703 acquires the carbon dioxide emission amount of the image forming system 701 by acquiring the carbon dioxide emission amount based on the power consumption of each processing and acquiring the amounts of carbon dioxide emitted due to the toner/sheet/consumable parts on a separate basis according to the processing type. With this, the carbon dioxide emission amount acquisition server 703 can acquire the carbon dioxide emission amount of the image forming system 701, i.e. the amount of carbon dioxide emitted by generation of a print product such that the amount of carbon dioxide directly emitted and the amount of carbon dioxide secondarily emitted are discriminable.

According to the present disclosure, it is possible to acquire the amount of carbon dioxide emitted by generation of a print product such that the amount of carbon dioxide directly emitted and the amount of carbon dioxide secondarily emitted are discriminable.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-162398 filed Sep. 19, 2024, which is hereby incorporated by reference herein in its entirety.

What is claimed is:

1. An information processing apparatus comprising:
a recording unit configured to record an execution time of each processing executed by an image forming apparatus or an image forming system including the image forming apparatus;
a first acquisition unit configured to acquire an amount of carbon dioxide emission of each processing executed by the image forming apparatus or the image forming system, by using a power consumption amount acquired by using the record recorded by the recording unit;
a second acquisition unit configured to acquire amounts of carbon dioxide emission due to consumables of the image forming apparatus or the image forming system on a separate basis according to a type of processing executed by the image forming apparatus or the image forming system; and
a third acquisition unit configured to acquire a carbon dioxide emission amount of the image forming apparatus or the image forming system, by using the amount of carbon dioxide emission acquired by the first acquisition unit and the amounts of carbon dioxide emission acquired by the second acquisition unit.

2. The information processing apparatus according to claim 1, wherein the first acquisition unit acquires the power consumption amount further by using a definition table defining power consumption of each processing executed by the image forming apparatus or the image forming system.

3. The information processing apparatus according to claim 1, wherein the second acquisition unit acquires amounts of carbon dioxide emission due to the consumables of the image forming apparatus or the image forming system, by using a conversion table for converting a used amount of each consumable of the image forming apparatus or the image forming system to a carbon dioxide emission amount.

4. The information processing apparatus according to claim 1, wherein the third acquisition unit acquires the carbon dioxide emission amount of the image forming apparatus or the image forming system, in a state separated into a first emission amount of carbon dioxide directly emitted by generation of a print product in the image forming apparatus or the image forming system and a second emission amount of carbon dioxide secondarily emitted by generation of the print product in the image forming apparatus or the image forming system, according to a type of processing executed by the image forming apparatus or the image forming system.

5. The information processing apparatus according to claim 4, wherein the third acquisition unit acquires the first emission amount on a separate basis for each job input to the image forming apparatus or the image forming system with reference to information related to jobs input to the image forming apparatus or the image forming system.

6. The information processing apparatus according to claim 4, wherein the third acquisition unit acquires the first emission amount on a separate basis for each client of a job input to the image forming apparatus or the image forming system with reference to information related to jobs input to the image forming apparatus or the image forming system.

7. The information processing apparatus according to claim 4, further comprising a display unit configured to display carbon dioxide emission amounts of the image forming apparatus or the image forming system on a display section in a state separated into the first emission amount and the second emission amount.

8. The information processing apparatus according to claim 7, wherein the display unit displays a first UI component on the display section, which is used by a user to cause the display unit to display only the first emission amount.

9. The information processing apparatus according to claim 7, wherein the display unit displays the first emission amount on a separate basis for each job input to the image forming apparatus or the image forming system with reference to information related to jobs input to the image forming apparatus or the image forming system.

10. The information processing apparatus according to claim 9, wherein the display unit displays a second UI component on the display section, which is used by a user to select a job for which details of the first emission amount are to be displayed.

11. The information processing apparatus according to claim 7, wherein the display unit displays the first emission amount on a separate basis for each client of a job input to the image forming apparatus or the image forming system with reference to information related to jobs input to the image forming apparatus or the image forming system.

12. The information processing apparatus according to claim 7, wherein the display unit displays a third UI component on the display section, which is used by a user to select a client of a job for which details of the first emission amount are to be displayed.

13. The information processing apparatus according to claim 7, wherein the display unit displays the carbon dioxide emission amount of the image forming apparatus or the image forming system on the display section, for a limited period of only a specific time period in which processing is executed by the image forming apparatus or the image forming system, with reference to information related to jobs input to the image forming apparatus or the image forming system.

14. The information processing apparatus according to claim 13, wherein the display unit displays a fourth UI component on the display section, which is used by a user to select the specific time period.

15. The information processing apparatus according to claim 7, wherein the display unit displays the carbon dioxide emission amount of the image forming system on the display section by limiting to a carbon dioxide emission amount of a specific apparatus included in the image forming system with reference to information related to jobs input to the image forming system.

16. The information processing apparatus according to claim 15, wherein the display unit displays a fifth UI component on the display section, which is used by a user to select the specific apparatus.

17. A method of controlling an information processing apparatus, comprising:
recording an execution time of each processing executed by an image forming apparatus or an image forming system including the image forming apparatus;
acquiring an amount carbon dioxide emission of each processing executed by the image forming apparatus or the image forming system, by using a power consumption amount acquired by the recording;
acquiring amounts of carbon dioxide emission due to consumables of the image forming apparatus or the image forming system on a separate basis according to a type of processing executed by the image forming apparatus or the image forming system; and
acquiring a carbon dioxide emission amount of the image forming apparatus or the image forming system, by using the amount of carbon dioxide emission acquired by the first acquisition unit and the amounts of carbon dioxide emission acquired by the second acquisition unit.

18. A non-transitory computer-readable storage medium storing a program for causing a computer to execute a method of controlling an information processing apparatus,
wherein the method comprises:
recording an execution time of each processing executed by an image forming apparatus or an image forming system including the image forming apparatus;
acquiring an amount carbon dioxide emission of each processing executed by the image forming apparatus or the image forming system, by using a power consumption amount acquired by the recording;
acquiring amounts of carbon dioxide emission due to consumables of the image forming apparatus or the image forming system on a separate basis according to a type of processing executed by the image forming apparatus or the image forming system; and
acquiring a carbon dioxide emission amount of the image forming apparatus or the image forming system, by using the amount of carbon dioxide emission acquired by the first acquisition unit and the amounts of carbon dioxide emission acquired by the second acquisition unit.
